(19) United States
(12) Patent Application Publication
(10) Pub. No.: US 2023/0348008 A1
(43) Pub. Date: Nov. 2, 2023

(54) CYCLE DRIVING DEVICE HAVING A TORQUE SENSOR

(71) Applicant: Moving Magnet Technologies, Besançon (FR)

(72) Inventor: Guillaume Keltz, Chatillon-le-Duc (FR)

(21) Appl. No.: 18/006,041

(22) PCT Filed: Jul. 16, 2021
(86) PCT No.: PCT/FR2021/051335

§ 371 Date: Jan. 19, 2023

(30) Foreign Application Priority Data
Jul. 20, 2020 (FR) FR2007608

(51) Int. Cl. B62J 45/411; B62M 6/60; B62M 6/50; B62M 6/55; G01L 3/10; B62J 45/421

(52) U.S. Cl. CPC B62J 45/411; B62M 6/60; B62M 6/50; B62M 6/55; G01L 3/104; B62J 45/421

(57) ABSTRACT

A cycle driving device has a torque sensor, a crankset axle or a hub connected to a plate by a coupling, and a driving and measuring member having a first section secured in rotation with the crankset axle or hub, and a second section connected to the plate. A magnetic field source is supported by one of the sections. The coupling member incorporates a torque detection device. The first and second sections cooperate through an elastically deformable element. The torque detection device comprises a fixed magneto-sensitive element that measures a magnetic field according to the relative angular position of the first and second sections, and is capable of converting the magnetic field into an electrical signal. The magnetic field measurement is performed at a single axial position in the periphery of the first and second sections independently of the rotation of the crankset axle or hub.

### CROSS-REFERENCE TO RELATED APPLICATIONS

This application is a national phase entry under 35 U.S.C. § 371 of International Patent Application PCT/FR2021/051335, filed Jul. 16, 2021, designating the United States of America and published as International Patent Publication WO 2022/018366 A1 on Jan. 27, 2022, which claims the benefit under Article 8 of the Patent Cooperation Treaty to French Patent Application Serial No. FR2007608, filed Jul. 20, 2020.

### TECHNICAL FIELD

The present disclosure relates to the field of electrically assisted cycles (electrically assisted bicycles and tricycles, more commonly called “electric bicycles”), and more particularly that of driving systems providing information on the power exerted by the cyclist on the pedals and incorporating a pedaling sensor for this purpose. The pedaling sensor is the element that transmits pedaling information to the computer. The pedaling sensors are important elements of the electric bicycle insofar as they control the level of assistance that the bicycle will provide, and therefore, in particular, its autonomy. The cyclist naturally adapts the speed of the bicycle to have ergonomic pedaling with minimal energy expenditure.

The electric motor starts when the cyclist presses the pedal. The pedaling sensor measures the torsional deformation of the axle of the crankset or of the hub of the driven wheel to deduce the torque it undergoes and therefore the pedaling power. Some torsion sensors also incorporate a rotation sensor and, by combining the two pieces of information, become power sensors. By measuring the torque and the speed of rotation, the computers are able to analyze the situation more finely and provide more proportional assistance based on the effort deployed.

The main challenges include proposing a sensor solution that is best suited to the efforts exerted by the cyclist while aiming for optimal mechanical integration, in the direction of reduced size, mass and electrical consumption. Moreover, the strong market penetration of these systems requires solutions that are increasingly adapted to mass production (simplicity, reliability, standardization, etc.).

### BACKGROUND

A large number of different pedaling sensors are known that are intended to measure the force developed by a cyclist on a cycle pedal. These devices use sensors of different types such as extensometers formed by strain gauges applied to elements of the cycle such as the wheels, the cranks of the crankset, the crankset axle and the pedal axles. However, such sensors are no longer suited to current challenges because they require electrical contact between the moving part and the fixed part, which is detrimental to their lifespan, and they are not compatible with mass production processes. An alternative then involves generating the power supply for the gauges and the transmission of the measurement information wirelessly, thus making this solution more complex. As a result, current developments are moving toward “contactless” solutions, mainly on an electromagnetic basis.

International Patent Application Pub. No. WO2012010344A1 describes a known example of a bracket for a bicycle. The bottom bracket comprises a shaft, a housing comprising two rolling bearings disposed at the side ends of the housing to mount the shaft, and a torque sensor disposed inside the housing to detect a torque exerted on the shaft. This torque sensor comprises a Hall effect sensor, a permanent magnet and a ferromagnetic marker. The permanent magnet and the marker are disposed radially spaced from each other on the shaft. The Hall effect sensor detects a change in position between the permanent magnet and the marker during a twist of the shaft, which is caused by the torque release. The solution described in this patent application has the drawback of generating a very small flux variation per degree of rotation of the torsion element. This limitation requires having a large angular deformation, typically greater than several degrees, to have sufficient measurement sensitivity. This constitutes a real limitation of this solution in the case of a torque sensor for an electric bicycle due to the introduction of an undesirable sensation of pedaling play.

International Patent Application Pub. No. WO2012055129 describes another known example of a torque and speed sensor for an electric bicycle that comprises a central rod, a crankset, a crank fixed to the central rod and a cage composed of an outer ring and an inner ring connected to one another by radial connecting bars. The inner ring is fixed to the crank and the outer ring is fixed to the crankset. Two magnets are disposed on the inner ring and their outer surfaces have opposite polarity. A Hall effect sensor is arranged to face the outer surfaces of the magnets. A rotating coil and a stationary coil are arranged coaxially on the central rod. These coils make it possible to transmit the signal from the Hall sensor, which is secured to the crankset and therefore in rotation. In this patent application, the proposed solution has two major drawbacks: on the one hand, the flux variation per degree of rotation of the torsion element generated by only two face-to-face magnets is low, which requires a large angular deformation of the torsion element. On the other hand, the Hall element is mobile, which requires the addition of, in particular, coaxial coils allowing signal transfer between the fixed part and the rotating part of the sensor. This system is expensive and bulky.

European Patent No. EP2225543B1 describes a crankset having a rotational torque detection system comprising at least one crankset crank, a shaft that is mounted secured in rotation with the crankset crank, and a rotation torque detection device in the region of the shaft. The rotational torque detection device has a direct magnetization of the shaft and a detector, which detects a change in the first magnetization based on the rotational torque introduced into the shaft. This solution, which uses a magnetization of a soft ferromagnetic material with low remanence, in fact generates a very weak magnetic field (and by extension magnetic field variations) and is therefore intrinsically very sensitive to measurement noise or external magnetic disturbances. It therefore requires multiple measuring elements that are sensitive to very weak magnetic fields in order to compensate for the disturbances, or even the use of additional pieces of ferromagnetic shielding. In addition, the measuring elements must be placed at a significant distance from one another, resulting in a greater axial bulk of the sensor, which impacts the positioning of the electric assistance motor. This additionally requires costly signal processing electronics. Furthermore, soft ferromagnetic materials capable of being magnetized in a stable manner and with sufficient remanence levels are relatively rare and specific, all the more so if they must also have the properties necessary for the mechanical functionality of this axle. This could therefore be expensive.

The solutions of the prior art use principles that make it possible to measure a very small signal variation. This leads, in addition to a large bulk, to having expensive signal processing electronics and a high sensitivity to external disturbances, or requires large deformations of the crankset axle providing undesirable user sensations. Moreover, some of these solutions require a rotating measuring element, which requires the addition of an information transmission system that is also expensive. Finally, the solutions of the prior art comprise a substantial number of parts, which compromises the robustness of cranksets with integrated force sensors. Indeed, it is an essential mechanical component of a bicycle, subject to multiple constraints:
short axis length, imposed by the limited lateral bulk;
limited cross-section to facilitate integration into a bicycle frame;
ability to transmit a very high instantaneous torque, without breaking, for example, during mountain bike jumps; and
resistance to dirt (dust, sand, mud, etc.).

### BRIEF SUMMARY

In order to respond to the drawbacks of the prior art, the present disclosure relates, according to its most general meaning, to a cycle driving system having a torque sensor, comprising a crankset axle or a hub connected to a plate by a coupling, driving and measuring member, having a first section secured in rotation with the crankset axle or hub and a second section connected to the plate, a permanent magnet supported by one of the sections, the coupling member incorporating a torque detection device, characterized in that:
the first and second sections cooperate through an elastically deformable element, and
the torque detection device comprises a fixed magneto-sensitive probe that measures a magnetic field according to the relative angular position of the first and second sections and is capable of converting the magnetic field into an electrical signal, the magnetic field measurement being performed at a single axial position in the periphery of the first and second sections independently of the rotation of the crankset axle or hub.

According to one embodiment, the torque sensor is an angular sensor comprising:
a first magnetized structure comprising a plurality of magnetized poles, secured to one of the sections, and
a second structure secured to the second of the sections, comprising two extended concentric chainrings of interlocking teeth,
the two concentric chainrings defining at least one air gap in which at least one magneto-sensitive element is placed that supplies an electrical signal depending on the magnetic field collected.

More particularly, the magnetized structure comprises a plurality of magnets in the form of a ring or a magnetized disc having a pole pitch of 3 mm to 4 mm.

The air gap can be achieved by a collector structure comprising two flux closure pieces inserted between the concentric chainrings.

According to another embodiment, the first and second sections cooperate on the one hand by the elastically deformable element and on the other hand by a stop limiting the angular stroke resulting from the elastic deformation of the coupling means.

More particularly, the elastically deformable element comprises a jaw coupling comprising at least one elastically deformable insert.

In a variant embodiment, the first section is secured to the elastically deformable element cooperating with a transmission gib passing through a slot formed in the first section to form a mechanical stop, the end of the gib being engaged in a longitudinal groove of the second section.

The driving member may comprise an additional sensor disposed close to the first magnetized structure cooperating with the magnetized ring to provide position or rate information.

The second section can be connected to the plate via a freewheel.

The present disclosure also relates to a mechatronic pedaling assistance system having a driving member in which the torque detection device controls the electric pedaling assistance supplied by an electric motor to the plate or to the support body of the rear wheel.

More particularly, the electric motor can be mechanically connected to the plate or to the support body of the rear wheel by means of a freewheel.

For example, the electric motor is a permanent magnet brushless electric motor. In a variant embodiment, the control electronics of the electric motor and of the angular sensor can be integrated on the same support.

In addition, the control of the electric motor can be carried out with an additional sensor providing position or rate information.

The electric motor and the torque sensor can be integrated into a module having simplified electrical connections.

In a variant, the module is integrated into a wheel and able to be mounted on a commercial cycle.

### BRIEF DESCRIPTION OF THE DRAWINGS

The present disclosure will be better understood on reading the following description, which concerns non-limiting embodiments.

FIG. 1 shows a schematic view of the kinematic chain on a crankset axle.

FIG. 2 shows a perspective view of a first variant embodiment of a coupling member according to the present disclosure during assembly.

FIG. 3 shows a perspective view of a first variant embodiment of a coupling according to the present disclosure after assembly.

FIG. 4A shows a perspective view of a first variant embodiment of a coupling member and associated torque and rate sensors for crankset according to the present disclosure during assembly.

FIG. 4B shows a sectional side view of the torque sensor for the crankset according to the present disclosure after assembly.

FIG. 5 shows a longitudinal sectional view of a second variant embodiment of a torque sensor for a crankset according to the present disclosure.

FIG. 6 shows a cross-sectional view of a second variant embodiment of a torque sensor for a crankset according to the present disclosure.

FIG. 7 shows a perspective view of a second variant embodiment of a torque sensor for a crankset according to the present disclosure.

FIG. 8 shows an exploded perspective view of a second variant embodiment of a torque sensor for a crankset according to the present disclosure.

FIG. 9 shows a perspective view of a variant embodiment of a coupling member according to the present disclosure.

FIG. 10A shows a schematic view of a variant embodiment of a hub torque sensor according to the present disclosure.

FIG. 10B shows a variant embodiment of a hub torque sensor according to the present disclosure.

FIGS. 11A-11C show perspective views of different variants of a hub torque sensor according to the present disclosure.

FIGS. 12A and 12B show perspective views of different variants of a hub torque sensor according to the present disclosure.

### DETAILED DESCRIPTION

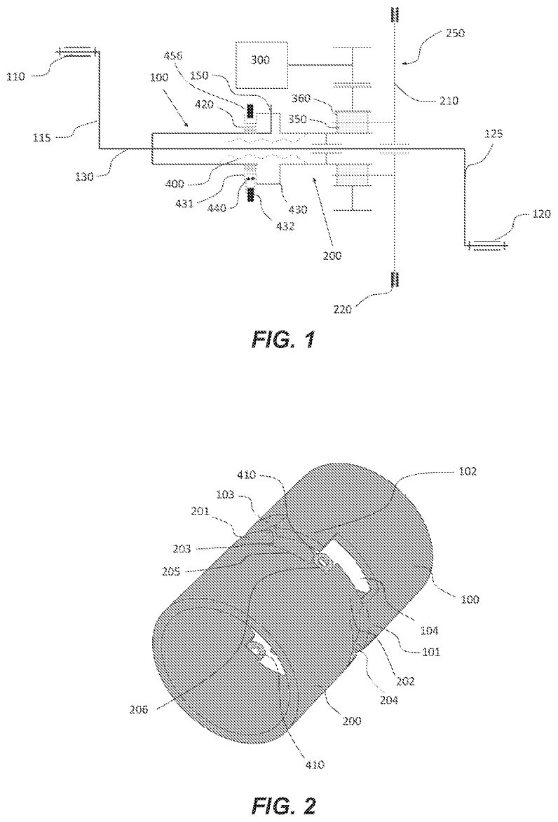

FIG. 1 shows a schematic view of the kinematic chain of a crankset according to the present disclosure. The crankset is the mechanical component of a bicycle that converts the reciprocating motion of the legs into rotational motion, which will be transformed into linear motion transmitted to the chain (220) that in turn will rotate the rear wheel.

Two pedals (110, 120) are each fixed to a crank (115, 125), opposite one another; the rotation of the axle (130) of the crankset indirectly drives a transmission system (250) comprising one or more plates (210), which will drive a chain (220) that in turn will drive the rear sprocket (or the freewheel or cassette) attached to the drive wheel.

In the case of an electrically assisted bicycle, the kinematic chain also comprises an electric motor (300) that drives the plate (250) via a freewheel (350).

The crankset axle (130) drives the plate (250) via a coupling member comprising two sections (100, 200) incorporating a torque sensor. The first section (100) is connected to the crankset axle (130), for example, by an annular notch. The second section (200) is connected to the plate (250). The two sections (100, 200) are coaxial and have angular play allowing one to rotate relative to the other. An elastically deformable element (400) is positioned between the first section (100) and the second section (200) to ensure the angular driving of one of the sections by the other section with an angular offset depending on the torque applied between the first and second section. This elastic element may comprise, without this being exhaustive, for example, cylindrical spring washers, deformable rubber or polymer elements, a torsion bar, a torsion tube, a spiral spring element or blades in deformation, or the like.

A stop (150) provided on one of the sections (100, 200) limits the angular displacement between the first section (100) and the second section (200).

When a rotational force is applied to one of the sections (100, 200), the latter drives the other section in rotation with a deformation of the elastically deformable element (400) depending on the resistance of the other section and therefore of the torque applied by the driving section to the driven section. When this torque exceeds a value leading to the maximum accepted deformation, the limiting stop (150) ensures an “infinite stiffness” coupling of the two sections (100, 200).

For a crankset, the forces normally applied to the crankset vary almost sinusoidally depending on the position of the pedal between around ten newton-meters and around fifty newton-meters, or even around a hundred newton-meters for a cyclist pedaling “out of the saddle,” and which can reach 250 to 300 newton-meters for a cycling champion. The characteristics of the coupling according to the present disclosure are to remain within the deformation range of the elastically deformable element (400) up to such a torque, the stiffness being defined according to the maximum torque in normal use, for example, 250 newton-meters. Beyond this value, the deformation of the elastically deformable element (400) leads to a relative displacement of the two sections (100, 200) such that they come into abutment, and any additional torque will no longer cause additional relative angular rotation between the two coaxial sections (100, 200), the two sections (100, 200) then constituting a single drive axis until the relative torque drops below the threshold value. This situation of exceeding the threshold value generally occurs exceptionally and temporarily, for example, during a mountain bike jump, and in fact leads to clipping of the torque measurement. It should be noted that the main purpose of the limiting stop (150) is to preserve the elastically deformable element (400) from excessive stresses that may lead to premature wear. This is especially valid for an “extreme” sporting use of the cycle, for example, for downhill mountain biking or by a champion cyclist in road use. In the context of a less intensive application, such as hybrid biking, the limiting stop (150) is optional and its removal leads to a simpler and less expensive design.

A magneto-sensitive probe angular position sensor (432) measures the relative angular position of the first section (100) with respect to the second section (200).

The rotation of the first section (100) with respect to the second section (200) takes place over the elastic deformation range of the elastically deformable element (400) where it is subjected to an increasing force as a function of the angular offset between the first section (100) and the second section (200), then the stroke limiter (150) becomes active and ensures the direct driving of the second section (200) by the first section (100).

Therefore, when a force exerted on the pedals (110, 120) begins, the first section (100) exerts a force on the elastically deformable element (400) that results in a deformation driving an angular displacement relative to the second section (200), until the torque reaches a value causing a deformation of the elastically deformable element (400) corresponding to the abutment of the stroke limiter (150). The second section (200) is then driven directly by the first section (100), as long as the torque exerted exceeds the threshold value defined by the deformation of the elastic element (400) and by the stroke limiter (150).

A magnetized structure (420) secured to the first section (100) provides a magnetic field channeled by a ferromagnetic structure (431) of the stator (430) secured to the second section (200), the ferromagnetic structure (431) forming an air gap (440) in which a magneto-sensitive probe (432) is disposed, such as a Hall probe, for example, which is mechanically decoupled in rotation with respect to the first and second sections (100, 200). The magneto-sensitive probe (432) measures the magnetic field variations inherent to the angular displacement of the magnetized structure (420) with respect to the ferromagnetic structure (431) of the stator. In order to present a total angular stroke of less than 2 degrees with the appropriate resolution, the magnetized ring (410) has alternating North and South poles with a pole pitch of between 3 mm and 4 mm, constituting a good compromise between linearity of the signal detected, mechanical feasibility and signal variation amplitude in the claimed context. The number of poles is then adapted according to the outer diameter of the magnetized ring (420), typically diameters ranging from 20 mm to 35 mm for a number of poles ranging from 16 to 32.

A second magneto-sensitive probe (456), mechanically decoupled in rotation with respect to the first and second sections (100, 200), is disposed on the periphery of the ferromagnetic structure (431). It is capable of directly measuring the magnetic field emanating either from the magnetized structure (420), or from another magnetized structure secured in rotation with the first section (100) or second section (200), this second magneto-sensitive probe (456) providing rate information.

It should be noted that all the elements requiring a supply of electric current, such as the magneto-sensitive probes (432, 456), are fixed with respect to the source of electric energy; they therefore do not require the use of expensive inductive systems, or sliding contact subjected to wear, to transmit an electrical signal to another element in relative rotation.

### First Variant Embodiment

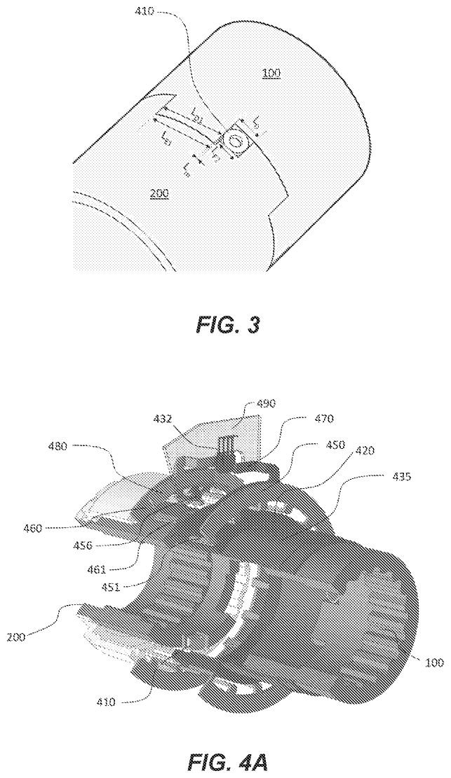

FIGS. 2 to 4B show views of a first variant embodiment of the coupling and measuring member according to the present disclosure.

The first section (100) comprises a tubular ring connected by fitting or by a groove with the axle (130) of the crankset.

The second section (200) comprises a tubular ring connected by fitting or by a groove with the axle of the plate (250).

The ends of the two sections (100, 200) have complementary shapes making it possible to transmit the torque between the two sections (100, 200), with a first limited angular region, where the torque is transmitted via a deformable element elastically composed of elastically deformable inserts (410), and then with driving of infinite stiffness, by the arrival in abutment.

The first section (100) has alternating teeth (101, 102) and indentations (103, 104), formed by cutting the tubular wall of the first section (100). The teeth (101; 102) have a bottom of constant height and side walls oriented along transverse planes.

The second section (200) also has alternating teeth (201, 202) and indentations (203, 204), formed by cutting the tubular wall of the second section (200). These indentations (203, 204) have two levels, the first level (205) corresponding to a height identical to the height of the teeth (101, 102) of the first section, and the second level (206) having a height less than the height of the teeth (101, 102) of the first section.

An elastically deformable insert (410), for example, an elastomeric capsule, is housed in the gap defined by the longitudinal edge of the tooth (202) of the second section, the bottom of the second level (206) of the adjacent indentation and the longitudinal edge of the tooth (102) of the first section (100). The angular width L₀ at rest of the elastically deformable insert (410) is greater than the angular width L_{E2} of the second level (206) of the indentation (203) of the second section (200). The difference between the two aforementioned angular widths corresponds to the measuring stroke Lₘ. It is understood that the two ends of the sections 100 and 200 can have N deformable inserts.

The angular width L_{D1} of a tooth (102) of the first section (100) is less than the angular width L_{E1} of the first level (205) of the indentation (203) of the second section (200). The aforementioned difference in angular width corresponds to the aforementioned measurement stroke and determines the relative angle before engagement with infinite stiffness of the two sections (100, 200).

The relationship between the angular widths are as follows:

Lₘ=L_{E1}−L_{D1}

L_{E1}+L_{E2}=L_{D1}+L₀ or L_{D1}=L_{E1}+L_{E2}−L₀

Typically:

0.1°≤Lₘ≤2°

0.5°≤L₀≤5°.

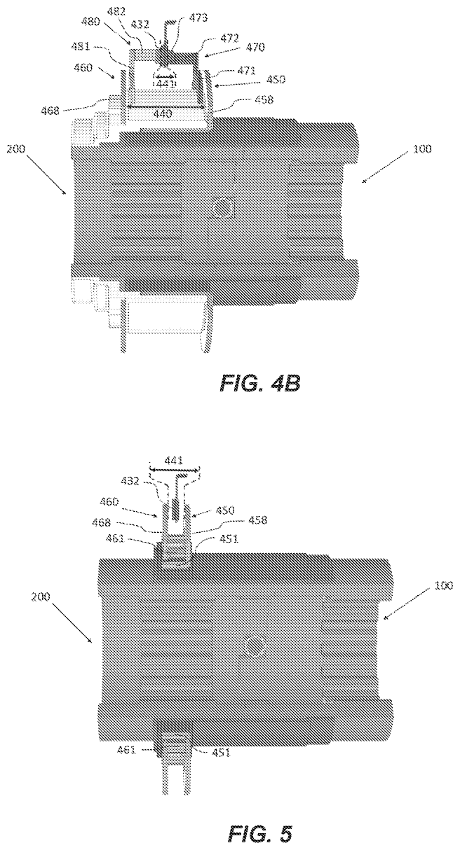

As illustrated in FIGS. 4A and 4B, the angular sensor has two primary collectors (450, 460) that are secured to the second section (200) and that define an air gap (440) in which secondary collectors (470, 480) are housed that are fixed relative to the frame of the bicycle. These secondary collectors (470, 480) are used to analyze the magnetic flux by producing a second air gap (441) in which a magneto-sensitive probe (432) is housed. The operating principle of this sensor is, for example, that described in patent EP1774272B1, the content of which is incorporated by citation in the present description.

Also positioned in the air gap (440) is a second magneto-sensitive probe (456), for example, a Hall probe, which is also fixed relative to the frame of the bicycle. The magneto-sensitive probe (456) makes it possible to detect one or more magnetic flux components so as to provide a signal relating to the angular position of the magnetized structure (420). By measuring the radial flux, it is possible, for example, to have access to a crenellated clock signal. The two magneto-sensitive probes (432, 456) are advantageously disposed on the same printed circuit (490).

FIG. 4B shows a cross-sectional side view of the coupling member, and in particular, of the angular sensor, in order to better appreciate the secondary collectors and the various air gaps.

The collection of the magnetic flux is ensured by a ferromagnetic structure (431) of the stator (430). The ferromagnetic structure (431) is angularly connected to the second section and is composed of two primary collectors (450, 460) having teeth disposed on a tubular casing, alternated, extended by annular concentrators. These are parts made of sheets of soft ferromagnetic material that are cut and bent.

The primary collectors (450, 460) are angularly connected to the second section. They are each formed by a concentrator (458, 468) having an annular disc portion in the transverse plane, extended by teeth (451, 461), visible in FIG. 4B, extending perpendicular to the plane of the concentrator (458, 468). The primary collectors (450, 460) are symmetrical and angularly offset so as to obtain interlocking of their teeth (451, 461) and to surround the magnetized structure (420).

The two concentrators (458, 468) define an air gap between them in which the secondary collectors (470, 480) are positioned. The first secondary collector (470) is formed by an annular concentrator (471) extending parallel to the first annular concentrator (458). It is extended by at least one leg (472) whose end (473) is curved to extend in a transverse plane, parallel to the curved end of the leg (482) extending a second annular concentrator (481), thus forming a second air gap (441). A magneto-sensitive probe (432) is placed in the second air gap (441) defined by the curved ends. The magneto-sensitive probe (432) is mounted on a printed circuit (490) and provides information on the angular position of the stator (430) relative to the magnetized structure (420), the measured magnetic flux varying sinusoidally when the magnetized structure moves angularly opposite the teeth (451, 461) of the stator (430). In order to exploit the measured signal more easily, the measured angular stroke is restricted to the region around the zero amplitude of the measured sine for which the amplitude variations are approximately linear as a function of the angle. A second magneto-sensitive probe (456) is disposed in the first air gap (440) and opposite the teeth (451, 461). The probe is fixed relative to the frame of the bicycle and is able to measure the magnetic flux of the magnetized structure (420) leaking radially, in particular, through the teeth (451, 461) so as to provide rate information, for example.

### Second Variant Embodiment

FIG. 5 shows a view of a second variant embodiment of the angular sensor. This embodiment differs from the previous one shown in FIGS. 4A and 4B in that the flux concentrators (458, 468) are not associated with secondary collectors, but directly define the air gap (441) in which the Hall probe (432) providing the angular information is inserted. This configuration is particularly advantageous when the axial size of the sensor must be reduced.

It is understood that the two variants of angular sensor presented here are only two non-limiting examples of the present disclosure. Patents WO02071019A1, WO06008425A1 and WO27077406A2, for example, present many other variants of angular sensor.

### Third Variant Embodiment

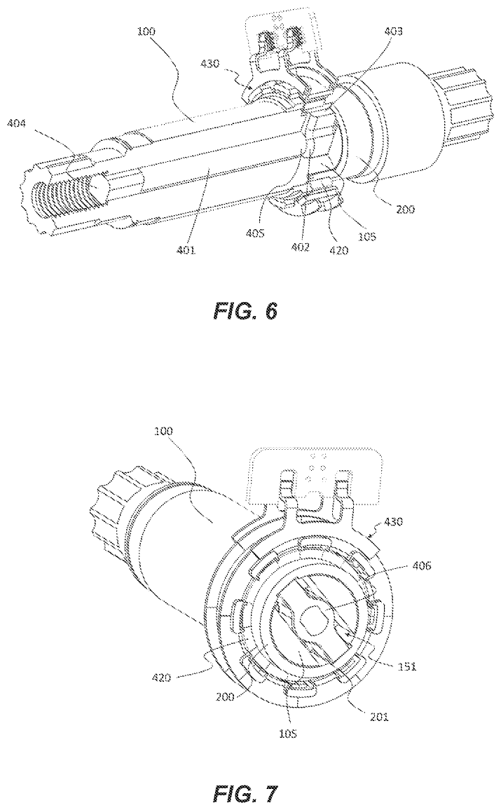

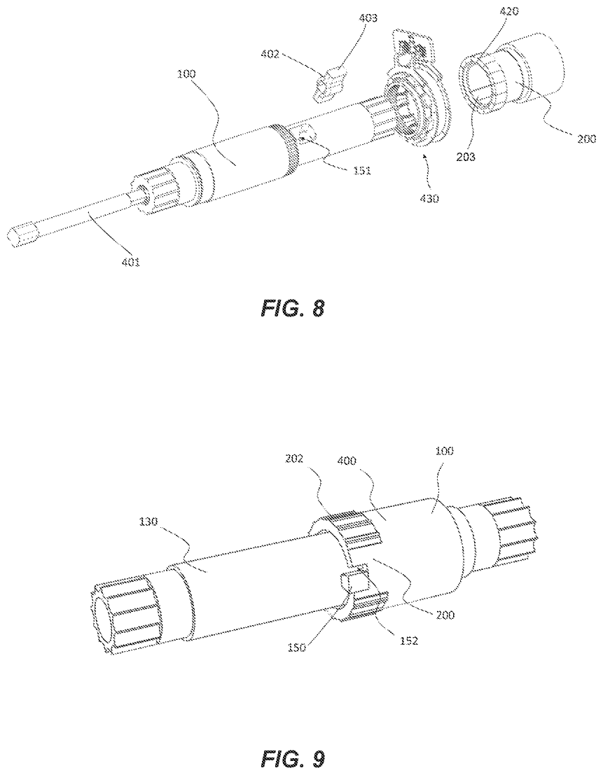

FIGS. 6 to 8 show views of a third variant embodiment of the coupling and measuring member according to the present disclosure.

This embodiment of the coupling member differs from the first embodiment in that the first and second sections (100, 200) of the coupling member no longer have the shapes of complementary teeth, but cooperate by sliding tubular fitting, the first section (100) having an axial protuberance (105) of outer diameter equal to the inner diameter of the second section (200), providing guidance of the second section (200) by the axial protuberance (105) of the first section.

The sections (100, 200) of the coupling member are then coupled using a shaft (401) provided with a finger (402), the shaft being housed inside the first section advantageously having a rectangular opening (151) in its radial section so as to receive the finger (402).

The shaft (401) is secured to the first section (100) on one end (404) and has an outer diameter smaller than the inner diameter of the first section so as to offer, by twisting of the shaft, a rotation of the finger located at its second end (405).

The finger (402) has, in the radial section, a cylindrical central bead (406) with a diameter equal to the width of the rectangular opening (151). The finger in connection with the first section (100) then has a single degree of rotational freedom, its angular stroke being limited by the geometric dimensions of the finger and of the rectangular opening.

The coupling of the first and second sections (100, 200) is therefore obtained by the cooperation of the radial ends of the finger (403) with an indentation (203) of the second section (200) so as to produce a slide connection thus blocking the relative rotation of the sections permitted by the cylindrical fitting. Thus, after assembly, the finger (402) is secured to the second section (200). As a corollary, the second section (200) can present a rotational movement relative to the first section (100) over a limited stroke and accompanied by the twisting of the shaft (401). Thus, in normal operating conditions, when torque is transmitted by the crankset axle to the first section (100), this torque is transmitted to the second section (200) via the shaft (401) and its finger (402) secured to the second section (200), the shaft (401) deforming in torsion in proportion to the value of the torque applied. During greater deformations, the finger (402) comes into contact with the inner wall of the opening (151) of the section (100). The over-torque is thus transmitted directly from the first section (100) of the shaft (401) to the second section (200) with “infinite” stiffness by the direct cooperation of the opening (151) with the finger (402).

This embodiment also differs from the previous embodiment in that the magnetized structure (420) is secured to the second section (200) and the stator is secured to the first section (100).

This embodiment finally differs in that the stator (430) of the angular sensor has an internal grooved shape cooperating with an external groove of the first section (100) so as to obtain a simplified assembly of these two elements.

### Fourth Variant Embodiment

FIG. 9 shows a variant embodiment of the torsion bar. This embodiment differs from the first embodiment in that the first and second sections (100, 200) are the axial ends of the elastically deformable element (400). The elastically deformable element (400) is a tubular shape through which the crankset axle (130) passes and is secured to the crankset axle (130) at the first section (100), the second section driving the plate (not shown) via a tooth (202). When torque is applied at the crankset axle (130), the deformation of the elastically deformable element (400) causes an angular offset of the stator (not shown), secured to the second section (200), relative to the magnetized structure (not shown), secured to the first section (100). The angular offset is thus measurable by the position sensor. Finally, it is noted that the second section (200) has an indentation (152) cooperating with the stop (150) so as to provide “infinite” rigidity in the event that too much torque is applied to the crankset axle (130), the torque then being transmitted directly from the crankset axle (130) to the second section (200) via the stop (150).

### Fifth Variant Embodiment

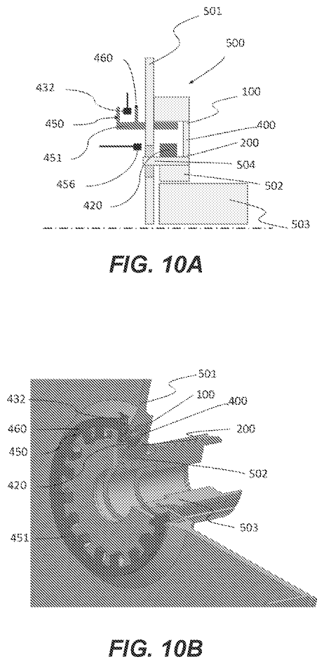

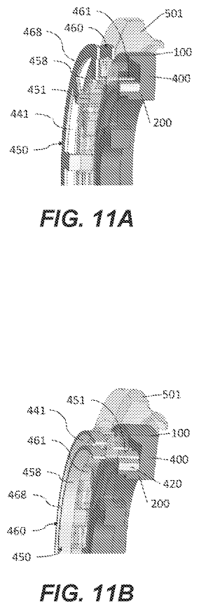

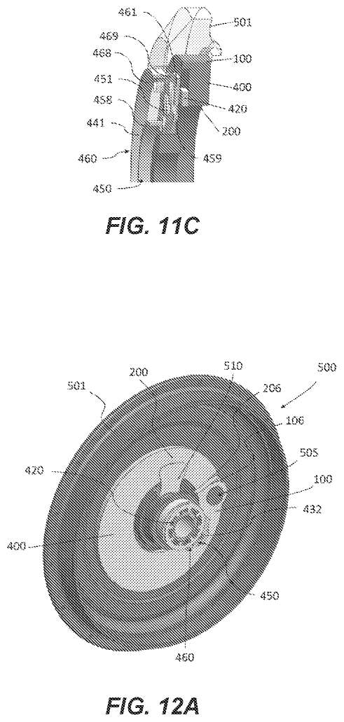

FIGS. 10A, 10B, and 11A-11C show a fifth variant embodiment of a hub according to the present disclosure. FIG. 10A shows a schematic view thereof. FIG. 10B shows an example of integration. The hub (500) of the driven wheel supports the magnetic structure of the position or deformation sensor, providing the torque and rate information. The elastically deformable element (400) is secured, at one of its ends (100), to the body of the hub (501) and, at its other end (200), to a freewheel mechanism (502), the freewheel mechanism (502) being connected with the support body (503) of the wheel, so as to transmit the torque unidirectionally between the support body (503) and the elastically deformable element (400), the support body (503) being mechanically connected to the crankset. In normal use, the torque provided by the user at the crankset is transmitted unidirectionally to the tread through the elastically deformable element (400), the body of the hub (501) being secured to the tread. In the event of excessive torque, the elastically deformable element (400) deforms until an axial extension (504), secured to the end (200), comes into contact with the hub body (501). The over-torque is then transmitted directly from the freewheel mechanism (502) to the hub body (501) via the axial extension (504) forming a stop.

As for the previous embodiments, the torque measurement is obtained using a magneto-sensitive probe (432), placed between in an air gap (441) defined by two primary (450) and secondary (460) collectors mechanically connected to the first section (100) of the elastically deformable element (400) and collecting the flux of the magnetized structure (420), the magnetized structure (420) being mechanically connected to the second section (200) of the elastically deformable element (400). In order to obtain the rate information, a second magneto-sensitive probe (456) makes it possible to detect the flux of the magnetized structure (420) leaking axially through the body of the hub (501). The two magneto-sensitive probes (432, 456), which are fixed with respect to the frame of the bicycle, can advantageously be assembled on the same electronic board.

FIGS. 11A-11C make it possible to assess different variants of the primary (450) and secondary (460) collectors. The collectors comprise concentrators (458, 468) extended by teeth (451, 461) radially capturing the flux of the magnetized structure (420) through multiple axial openings in the body of the hub (501), as shown in FIGS. 11A and 11B. These two figures are distinguished by the arrangement of the concentrators (458, 468) in that they define a radial air gap (441) in FIG. 11A and an axial air gap (441) in FIG. 11B. As shown in FIG. 11C, the flux from the magnetized structure (420) can also be collected axially, the teeth (451, 461) then spreading out radially and oppositely from concentric annular concentrators (459, 469). This embodiment advantageously makes it possible to minimize the number of axial openings present in the body of the hub to convey the collected flux toward the concentrators (458, 468) defining the air gap (441).

### Sixth Variant Embodiment

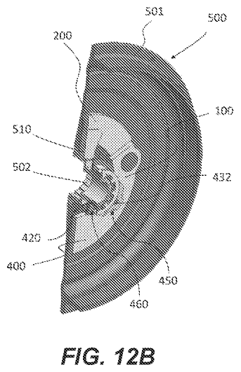

FIGS. 12A and 12B show a variant embodiment of a hub according to the present disclosure. As for the previous embodiment, the hub (500) of the driven wheel supports the magnetic structure of the deformation sensor providing the torque and rate information. This embodiment nevertheless differs in that the elastically deformable element (400) has the shape of a disc sectioned to present two radial ends (100, 200). The elastically deformable element (400) is connected, at one of its ends (100), to the body of the hub (501) through an axial protuberance (505) and, at its other end (200), to the freewheel mechanism (502) through a tubular part (510) having a radial protuberance fitting into the elastically deformable element (400). The freewheel mechanism (502) is connected to the support body of the wheel (not shown), so as to transmit the torque unidirectionally between the support body and the elastically deformable element (400), the support body being mechanically connected to the crankset. In normal use, the torque provided by the user at the crankset is transmitted unidirectionally to the tread through the elastically deformable element (400), the body of the hub (501) being secured to the tread. In the event of excessive torque, the elastically deformable element (400) deforms tangentially until the radial wall (106) of its first end (100) comes into contact with the radial wall (206) of its second end (200). The over-torque is then transmitted directly from the freewheel mechanism (502) to the hub body (501) via the radial walls (106 and 206) that are then in contact. When these radial walls (106 and 206) are in contact, the stiffness then becomes very high.

As for the previous embodiments, the torque measurement is obtained using a magneto-sensitive probe (432), placed between in an air gap (441) defined by two primary (450) and secondary (460) collectors mechanically connected to the first section (100) of the elastically deformable element (400) and collecting the flux of the magnetized structure (420), the magnetized structure (420) being mechanically connected to the second section (200) of the elastically deformable element (400), the magneto-sensitive probe (432) being fixed relative to the frame of the bicycle.

1. A cycle driving device having a torque sensor, comprising:
a crankset axle or a hub connected to a plate by a coupling member;
a driving and measuring member having a first section secured in rotation with the crankset axle or hub, and a second section connected to the plate;
a permanent magnet supported by one of the first section and the second section of the driving and measuring member;
a torque detection device incorporated in the coupling member,
wherein the first and second sections cooperate through an elastically deformable element; and
wherein the torque detection device comprises a fixed magneto-sensitive probe that measures a magnetic field according to the relative angular position of the first section and the second section and is capable of converting the magnetic field into an electrical signal, the magnetic field measurement being performed at a single axial position in the periphery of the first section and the second section independently of the rotation of the crankset axle or hub.

2. The device of claim 1, wherein the torque sensor is an angular sensor comprising:
a first magnetized structure comprising a plurality of magnetized poles, the first magnetized structure secured to one of the first section and the second section; and
a second structure secured to another of the first section and the second section; the second structure comprising two extended concentric chainrings of interlocking teeth, the two concentric chainrings defining at least one air gap in which at least one magneto-sensitive element is placed that supplies an electrical signal depending on the magnetic field collected.

3. The device of claim 2, wherein the first magnetized structure comprises a plurality of magnets in the form of a ring or a magnetized disc having a pole pitch of 3 mm to 4 mm.

4. The device of claim 2, wherein the air gap is defined by a collector structure comprising two flux closure pieces inserted between the concentric chainrings.

5. The device of claim 1, wherein the first section and the second section cooperate by the elastically deformable element and by a stop limiting the angular stroke resulting from the elastic deformation of the coupling member.

6. The device of claim 1, wherein the elastically deformable element comprises a jaw coupling comprising at least one elastically deformable insert.

7. The device of claim 1, wherein the first section is secured to the elastically deformable element cooperating with a transmission gib passing through a slot formed in the first section to form a mechanical stop, an end of the gib being engaged in a longitudinal groove of the second section.

8. The device of claim 2, further comprising an additional sensor disposed close to the first magnetized structure and cooperating with the first magnetized structure to provide position or rate information.

9. The device of claim 1, wherein the second section is connected to the plate via a freewheel.

10. A mechatronic pedaling assistance system having a driving device according to claim 1, wherein the torque detection device controls electric pedaling assistance supplied by an electric motor to the plate or to the support body of a rear wheel.

11. The system of claim 10, wherein the electric motor is mechanically connected to the plate or to the support body of the rear wheel by a freewheel.

12. The system of claim 10, wherein the electric motor comprises a permanent magnet brushless electric motor.

13. The system of claim 10, further comprising control electronics for the electric motor and for the angular sensor integrated on a same support.

14. The system of claim 10, further comprising an additional sensor configured to provide position or rate information for controlling the electric motor.

15. The system of claim 10, wherein the electric motor and the torque sensor are integrated into a module having electrical connections.

16. The system of claim 15, wherein the module is integrated into a wheel and configured to be mounted on a cycle.
